(19) United States
(12) Patent Application Publication
(10) Pub. No.: US 2005/0114238 A1
(43) Pub. Date: May 26, 2005

(54) Method and apparatus for screening inventory for defective hard drives

(76) Inventors: Dhiren Thakorlal Sutaria, E. Irvine, CA (US); Marsha Lani Namba, Huntington Beach, CA (US); Suresh Kumar Sivapuram, San Jose, CA (US); Richard Milton Silver, Felton, CA (US); Gordon Stark, Felton, CA (US); Ronald Lane, San Jose, CA (US); David Van Peck, Edmond, OK (US)

Correspondence Address: Raghunath S. Minisandram;Seagate Technology LLC, 920 Disc Drive, SV15B1, Scotts Valley, CA, 95067, US

(21) Appl. No.: 10/794,128

(22) Filed: Mar. 4, 2004

Related U.S. Application Data
(60) Provisional application No. 60/452,252, filed on Mar. 4, 2003.

(51) Int. Cl. G06F 17/60; G06F 1/16

(52) U.S. Cl. 705/28

(57) ABSTRACT

Embodiments of the invention generally provide a disk drive inventory data processing system. In one embodiment, the disk drive inventory data processing system is configured as a mobile hub sorting system (MHSS) that is adapted to receive and processes data from an independent disk drive inventory management system such as a disk drive inventory distribution hub. The disk drive inventory data processing system determines the status of the disk drive inventory and then segregates the disk drives into distributable and not distributable pallets, cartons, and individual disk drives. In another embodiment, the disk drive inventory data processing system provides processed disk drive inventory information to update the independent disk drive inventory system on the shipping status of the disk drives, pallets, and cartons.

### CROSS-REFERENCE TO RELATED APPLICATIONS

This invention is based on U.S. Provisional Patent Application Ser. No. 60/452,252 filed Mar. 4, 2003 entitled “Method For Screening Inventory For Defective Hard Drives” filed in the name of Dhiren Thakorlal Sutaria, Marsha Lani Namba, Suresh Kumar Sivapuram, Richard Milton Silver, Gordon Stark, Ronald Lane, and David Van Peck. The priority of this application is hereby claimed and it is hereby incorporated herein by reference thereto.

### BACKGROUND OF THE INVENTION

1. Field of the Invention

The invention relates generally to inventory control systems. More particularly, the present invention relates to inventory control systems used to process the status and disposition of disk drive inventory.

2. Description of the Related Art

Generally, disk drives are capable of storing large amounts of digital data in a relatively small area. Disk drives are currently used for many data storage functions. For example, disk drives may be used to store large amounts of data and software programs for use with computers. Disk drives may also be used to store data for other types of equipment such as multimedia players, printers, etc. As the demand for disk drives has increased, so has the need to manufacture disk drives efficiently and cost effectively.

After manufacture, a disk drive is conventionally stored in a warehouse as inventory for distribution to consumers and other manufacturers. Unfortunately, storing inventory requires warehouse space, staff to maintain the inventory, and accounting costs, which tends to increase the cost of the inventory and ultimately the price of the products using such inventory. To overcome inventory issues, many manufacturers use a just-in-time (JIT) approach to manufacturing. Using JIT manufacturing techniques, inventory may be built in more synchronization with the demand. Thus, such JIT systems may effectively lower inventory and thereby decrease manufacturing costs.

Manufacturers often set up a JIT hub warehousing system to facilitate the distribution of their JIT inventory. Many companies outsource JIT distribution hub system to third parties to minimize onsite costs and space required to manage such JIT distribution hubs. Unfortunately, third party JIT distribution hubs are generally set up for generic inventory distribution and may not be fully equipped with the tools and personnel necessary to discern shippable inventory from not shippable inventory, e.g., inventory that may be deemed defective and not distributable for further processing. This is particularly the case with disk drives that are stored on pallets where some of the disk drives are shippable while others may be not shippable due to damage, etc.

To overcome this issue, disk drive manufacturers have tended to send disk drives to custom third party JIT distribution hubs that have the tools and personnel necessary to handle disk drive distribution needs. Unfortunately, such third party JIT distribution centers are often more expensive due to the custom nature of their systems.

Disk drive manufacturers may rely on disk drive attribute tracking to reduce the number of disk drives that are not shippable. Unfortunately, such attribute tracking increases the need to sort through disk drives at the pallet and even the carton level. Further, without such detailed tracking distribution throughput may be significantly reduced. For example, one defective disk drive may stop the shipment of a pallet of good disk drives.

Therefore, a need exists for a method and system to effectively identify and process shippable and not shippable disk drive inventory that is easy to use and is cost effective.

### SUMMARY OF THE INVENTION

An embodiment of the present invention is method of segregating disk drive inventory into distributable disk drive inventory and not distributable disk drive inventory. The method includes determining if at least one of the disk drive inventory is not distributable using at least some disk drive attribute data associated with one or more of the disk drive inventory, associating a not distributable status with the not distributable disk drive inventory, and associating a distributable status with the distributable disk drive inventory.

An embodiment of the present invention is a method of identifying and physically separating physical disk drive inventory into distributable disk drive inventory and not distributable disk drive inventory. The method includes retrieving inventory data from the physical disk drive inventory, determining from the retrieved disk drive inventory data a type of packaging associated with the disk drive inventory, and comparing disk drive attribute data of the disk drive inventory to data indicative of a not distributable status of the disk drive inventory. The method further includes determining if the disk drive inventory associated with the packaging is not distributable from the comparison between the attribute data and data indicative of a not distributable status, if the disk drive inventory within the inventory package is determined to be not distributable then generating data indicative thereof. If at least some of the disk drive inventory associated with the inventory package is not distributable then determining if the disk drive inventory within the package is segregable into distributable disk drive inventory and not distributable disk drive inventory.

An embodiment of the present invention is a system for identifying and separating disk drive inventory distributable to one or more inventory locations into distributable disk drive inventory and not distributable disk drive inventory. The system includes a memory means containing a disk drive inventory processing program and a list of disk drive distribution statuses. The system further includes a processor means which, when executing the inventory processing program is configured to retrieve disk drive inventory data from the disk drive inventory and determine from the retrieved disk drive inventory data a type of packaging associated with the disk drive inventory. The processor is further configured to compare disk drive attribute data of the disk drive inventory to data indicative of a distributable status of the disk drive inventory and determine from the comparison the distributable disposition of the package.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a high-level illustration of an inventory data processing system in accordance with embodiments of the invention.

FIG. 2 is a high-level flow diagram illustrating one embodiment of a method of processing disk drive inventory data associated with disk drive inventory in accordance with embodiments of the invention.

FIG. 3 is a high-level flow diagram illustrating one embodiment of a method of processing disk drive inventory data associated with disk drive inventory in accordance with embodiments of the invention.

FIG. 4 is a high-level flow diagram of one embodiment of a method of obtaining data from disk drive inventory in accordance with embodiments of the invention.

FIG. 5 is a high-level flow diagram of one embodiment of a method of determining the disposition of palletized disk drive inventory in accordance with embodiments of the invention.

FIG. 6 is a high-level flow diagram of one embodiment of a method of determining distributable disposition of one or more cartons of disk drive inventory in accordance with embodiments of the invention.

FIG. 7 is a high-level flow diagram of one embodiment of a method of determining distributable disposition of disk drive inventory in accordance with embodiments of the invention.

FIG. 8 is a high-level flow diagram of one embodiment of a method of overriding distributable package status in accordance with embodiments of the invention.

FIG. 9 is a high-level flow diagram of one embodiment of a method of overriding a distributable status of a pallet in accordance with embodiments of the invention.

FIG. 10 is a high-level flow diagram of one embodiment of a method of overriding a distributable status of a carton of disk drive inventory in accordance with embodiments of the invention.

FIG. 11 is a high-level flow diagram of one embodiment of a method of overriding a distributable status of disk drive inventory in accordance with embodiments of the invention.

FIG. 12 is a high-level flow diagram of one embodiment of a method of processing disk drive inventory distributable status data in accordance with embodiments of the invention.

FIG. 13 is a high-level flow diagram of one embodiment of a method of reconciling disk drive inventory data in accordance with embodiments of the invention.

### DETAILED DESCRIPTION OF THE PREFERRED EMBODIMENTS

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

Embodiments of the present invention are described in terms of wireless communication systems such as defined in IEEE 802.11, and networks such as Wireless Local Area Network (WLAN), Wireless Wide Area Networks (WWAN), and other networks utilizing data packet communication such as the Internet. However, It is understood the present invention is not limited to any particular communication system or network environment.

For purposes of clarity, disk drive inventory 156 is described herein in terms of physical disk drive inventory stored in a centralized location such as a distribution warehouse, e.g. hub, on pallets, in cartons, and individual disk drive packages. However, it is contemplated that such physical disk drive inventory may be stored in virtually any inventory location and packaging. For example, disk drive inventory may be stored in an inventory storage location such as finished goods (FG) inventory, e.g. an inventory distribution center (DC), just-in-time (JIT) distribution hubs, work in progress (WIP) storage, and the like, where disk drive inventory may be distributed therefrom to other inventory locations and facilities for storage and further processing.

Embodiments of the present invention include labeling disk drive inventory as is known in the art. For example, disk drive inventory may be labeled using standard hand written labels, computer generated labels such as bar code labels, and other labels. Other labeling techniques are contemplated such as stamping, etching, screening, and the like. Such labeling may be used present data associating such disk drive inventory to, for example, an inventory location, disk drive model, software revision, firmware revision, bin number, pallet, carton, case number, serial number, data of manufacture, distributable status, i.e., shippable or not shippable to other locations, and the like. Herein, distributable is defined as equivalent in meaning to the term shippable.

As will be described below, embodiments of the present invention pertain to specific method steps implementable on computer systems. In one embodiment, the invention may be implemented as a computer program-product for use with a computer system. The programs defining the functions of at least one embodiment can be provided to a computer via a variety of computer-readable media (i.e., signal-bearing medium), which include but are not limited to, (i) information permanently stored on non-writable storage media (e.g. read-only memory devices within a computer such as read only CD-ROM disks readable by a CD-ROM or DVD drive;
(ii) alterable information stored on a writable storage media (e.g. floppy disks within diskette drive or hard-disk drive); or (iii) information conveyed to a computer by communications medium, such as through a computer or telephone network, including wireless communication. The latter specifically includes information conveyed via the Internet. Such signal-bearing media, when carrying computer-readable instructions that direct the functions of the invention, represent alternative embodiments of the invention. It may also be noted that portions of the product program may be developed and implemented independently, but when combined together are embodiments of the invention.

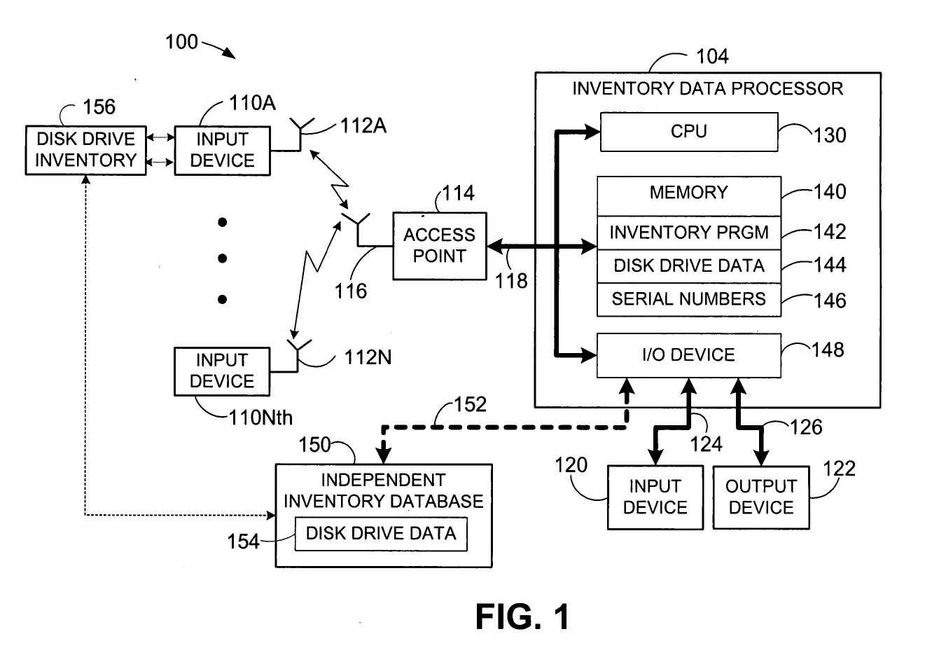

FIG. 1 is a high-level illustration of an inventory data processing system 100 in accordance with embodiments of the invention. Inventory data processing system 100 includes an inventory data processor 104 wirelessly coupled to one or more input devices 110A though 110N via wireless access point 114. Wireless access point 114 includes antenna 116 configured to wirelessly couple device 110A though 10N via a respective antenna 112A-112N coupled thereto as is known in the art. Input device 110N and antenna 112N are defined herein as an Nth number, i.e., a plurality of input devices 110A-N and respective antennas 112A-N. Input devices 110A-N may be virtually any type of device configured to retrieve, e.g., scan, input, etc. data from disk drive inventory 156. For example, input devices 110A-N may be infrared radio frequency (RF) bar code scanning devices configured to read barcodes from disk drive inventory labels, some of which are described herein, for attribute data collection thereof. For clarity, wireless communication is described herein between input devices 110A-N and inventory data processor 104, however it is contemplated that one or more input devices 110A-N may be connected using other connection techniques as are known such as hardwired connections, optical connections, and the like, to inventory data processor 104. Inventory data processor 104 may communicate with one or more input devices 110A-N using data communication techniques as are known such as Ethernet, USB, firewire (IEEE 1394), serial communication, parallel communication, infrared communication, and the like.

To receive external data from a user or operator, inventory data processor 104 may also be in communication with an input device 120 via signal 124. Input device 120 can be virtually any device to give input to inventory data processor 104. For example, a keyboard, keypad, light-pen, touch-screen, track-ball, or speech recognition unit, audio/video player, and the like could be used for input device 120. To output information, inventory data processor 104 may be in communication with an output device 122 via signal 126. The output device 122 can be virtually any device to give output from inventory data processor 104 to a user thereof, e.g., any conventional display screen, printer, set of speakers along with their respective interface cards, i.e., video card and sound card, etc. Although shown separately from the input device 120, output device 122 and input device 120 could be combined. For example, a display screen with an integrated touch-screen, a display with an integrated keyboard, or a speech recognition unit combined with a text speech converter could be used.

Inventory data processor 104 may be virtually any type of data processing system such as a laptop computer, desk top computer, mainframe, personal data assistant (PDA), and the like, that may be configured to perform embodiments of the present invention to advantage. In one embodiment, inventory data processor 104 includes Central Processing Unit (CPU) 130, memory 140, and an input/output (I/O) device 148 in communication therewith via bus 118. Bus 118 may be configured to couple data associated with the transmission of data from input devices 110A-N from wireless access point 114 to CPU 130, memory 140 and I/O device 148, for example. CPU 130 may be under the control of an operating system that may be disposed in memory 140. Virtually any operating system or portion thereof supporting the configuration functions disclosed herein may be used. Memory 140 is preferably a random access memory sufficiently large to hold the necessary programming and data structures of the invention. While memory 140 is shown as a single entity, it should be understood that memory 140 may in fact comprise a plurality of modules, and that memory 140 may exist at multiple levels, from high speed registers and caches to lower speed but larger direct random access memory (DRAM) chips.

Illustratively, memory 140 may include inventory data processing program 142 that, when executed on CPU 130, controls at least some data processing operations of inventory data processing system 100. The inventory data processing program 142 may use any one of a number of different programming languages. For example, the program code can be written in PLC code (e.g., ladder logic), a higher-level language such as C, C++, Java, or a number of other languages. While inventory data processing program 142 may be a standalone program, it is contemplated that inventory data processing program 142 may be combined with other programs.

In one embodiment, memory 140 may include disk drive data 144. Disk drive data 144 may utilize and be part of a database program such as Microsoft Access™, Oracle® database, and other data base programs configured to store data for processing thereof. Disk drive data 144 may be processed by inventory data processor 104 to process information associated with disk drive inventory 156 including data associated with individual disk drives, cartons of disk drives, pallets of disk drives, and the like associated with independent disk drive inventory data base 150. Disk drive data 144 may include disk drive inventory attributes such as stop disk drive shipment data, revision data, sub-inventory, bin data, item data, pallet data, top data, case data, date of manufacturer, predefined serial attributes data, and the like. Memory 140 may include disk drive serial number data 146 associated with one or more disk drive inventory 156. In one configuration, disk drive data 144 includes a distributable status associated with disk drive inventory 156. For example, disk drive data 144 may include data that associates disk drive inventory 156 to a distributable status or not distributable status such that warehouse personnel, data operators, robotic systems, etc., may be able to differentiate distributable physical disk drive inventory from disk drive inventory not distributable, e.g., defective disk drives, etc. Herein, for clarity embodiments of the present invention are described in terms of an operator, however it is contemplated that an operator may be a user, a system administrator, third party user, computer tracking system, and include virtually any personnel and machine capable of utilizing data processed by inventory data processing system 100.

I/O device 148 may be configured to output data on bus 118 in response to data received from input device 120 via signal 124. I/O device may be configured to output data to output device 122 via signal 126 in response to data received from CPU 130 transmitted to I/O device 148 via bus 118. I/O device may be configured to output data on bus 118 in response to such data accessed from external independent inventory databases 150 via signal 152. Such data from external independent inventory database may include data indicative of disk drive inventory stored in one or more inventory locations. For example, independent inventory database 150 may contain attribute data described herein about a number of disk drive inventory 156 and an associated inventory packaging type such as a pallet, carton, box, shelf, and the like.

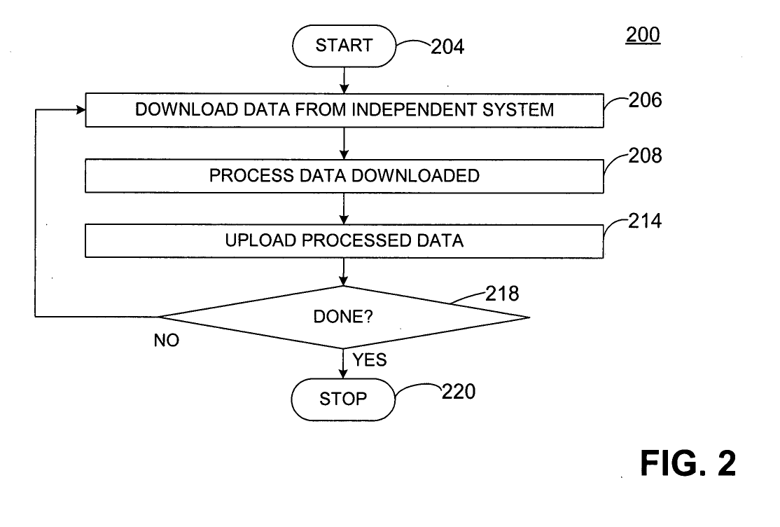

FIG. 2 is a high-level flow diagram illustrating one embodiment of a method 200 of processing disk drive data 154 associated with disk drive inventory 156 in accordance with embodiments of the invention. Method 200 may be entered into at 204 when, for example, inventory data processing program 142 is activated. At 206, disk drive data 154 from independent inventory system 150 and data retrieved from disk drive inventory 156 are downloaded into memory 140. In one configuration, data retrieved from disk drive inventory 156 and disk drive data 154 may be stored in disk drive data 144. At 208, disk drive data 154 and data retrieved from disk drive inventory 156 are processed to determine a distributable disposition of disk drive inventory 156. In one configuration, processing of disk drive data 154 and data retrieved from disk drive inventory 156 may include determining if a disk drive inventory location is configured to allow cartons of disk drives to stand alone, configured to allow disk drives to stand alone, determine maximum quantity of disk drives allowed, determine a maximum quantity of cartons allowed, and the like. Processing may include determining if at least one of the disk drive inventory 156 is distributable, i.e., shippable for further processing, by comparing data retrieved from disk drive inventory 156 with disk drive data 144, then associating a distributable status with the distributable disk drive inventory 156 and associating a not distributable status with the not shippable disk drive inventory 156. At 214, method 200 uploads and updates such processed disk drive data 154 and data retrieved from disk drive inventory 156 to independent inventory system 150 via signal 152. If at 218 method 200 is finished, method 200 proceeds to 220 and ends. If however, method 200 is not finished at 218, method 200 proceeds to 206.

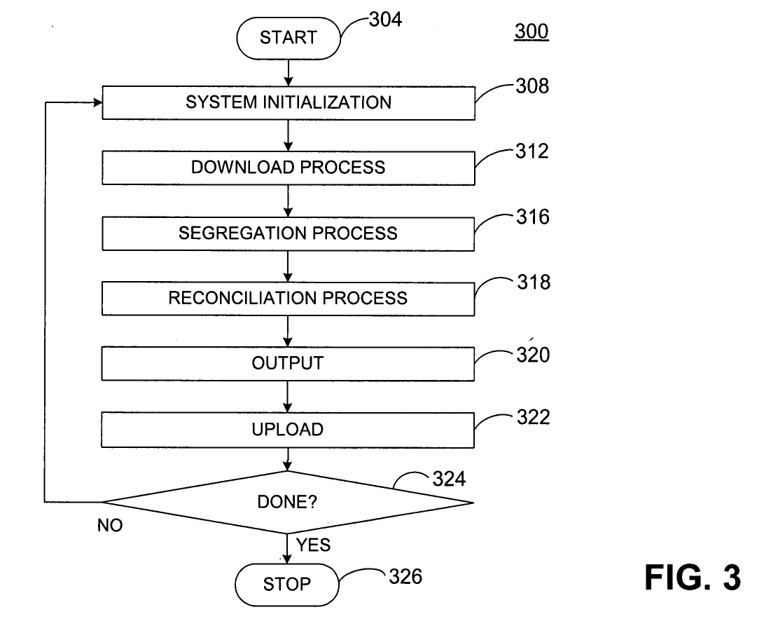

FIG. 3 is a high-level flow diagram illustrating one embodiment of a method 300 of processing disk drive inventory data 154 associated with disk drive inventory 156 in accordance with embodiments of the invention. Method 300 may be entered into at 304 when, for example, inventory data processing program 142 is activated. At 308, a system initialization is performed. Such a system initialization may include providing pre-defined settings for inventory data processor 104 such as number of system operators, access to data operations, reporting, and the like.

At 312, method 300 retrieves disk drive data 154 from independent disk drive inventory database 150 associated with at least one inventory location and retrieves data associated with disk drive inventory 156. For example, input devices 110A-N may be used by operators to scan data labels associated with disk drive inventory 156 such as data labels disposed on pallets of disk drives, cartons of disk drives, individual disk drives, and the like. Such scanned data may be stored in memory 140 within disk drive data 144, for example. At 316, disk drive data 154 and data retrieved from disk drive inventory 156 are processed to segregate disk drive inventory 156 into distributable and not distributable disk drive inventory 156. In one configuration, such segregation is performed by comparing disk drive data 154 and data retrieved from disk drive inventory 156 with disk drive data 144. Such segregation process may include comparing disk drive data 144, that includes distributable disk drive status, to disk drive data 154 and data retrieved from disk drive inventory 156 to determine which portion of disk drive inventory 156, such as a pallet of disk drives, a carton of disk drives, or individual disk drives, etc., are distributable to other inventory locations such as a FG inventory.

A reconciliation process is initiated at 318. Such a reconciliation process may be used to reconcile independent inventory database 150 with segregation data from segregation process 316 described above. For example, such a reconciliation process may include adjusting disk drive data 154 to about match such a segregation process performed at 316. Such a reconciliation process may also include generating reconciliation reports for operators, third parties, etc. Such reconciliation reports may provide distributable status for at least some of the disk drive inventory 156. Such a reconciliation process may include data generation operations described herein such as, for example, providing data associated with re-labeling at least some disk drive inventory 156 corresponding to an associated distributable status, providing data associated with repackaging independent disk drive inventory 156 into distributable and not distributable disk drive inventory, and the like. Such a reconciliation process may also be configured to allow an operator such as a system administrator to have access to uploaded data from independent inventory database 150, disk drive data 144, parameters associated with system initialization, account access, assignment of security levels, passwords, and the like, as described further herein.

At 320, method 300 provides an output of processed disk drive data associated with independent inventory database 150 to an operator such as a system administrator. In one embodiment, such processed disk drive data may be outputted in a format such as a flat file, database format, and the like usable by a database such as independent inventory database 150, and the like, for further storage and processing. Such a data output may include outputting operations such as outputting a reconciliation report as described above, printing disk drive inventory labels, and the like, for example. At 322, method 300 uploads such processed data from 320 to independent inventory system 150. If at 324 method 300 is finished, method 300 proceeds to 326 and ends. If however, if method 300 is not finished at 324, method 300 proceeds to 308.

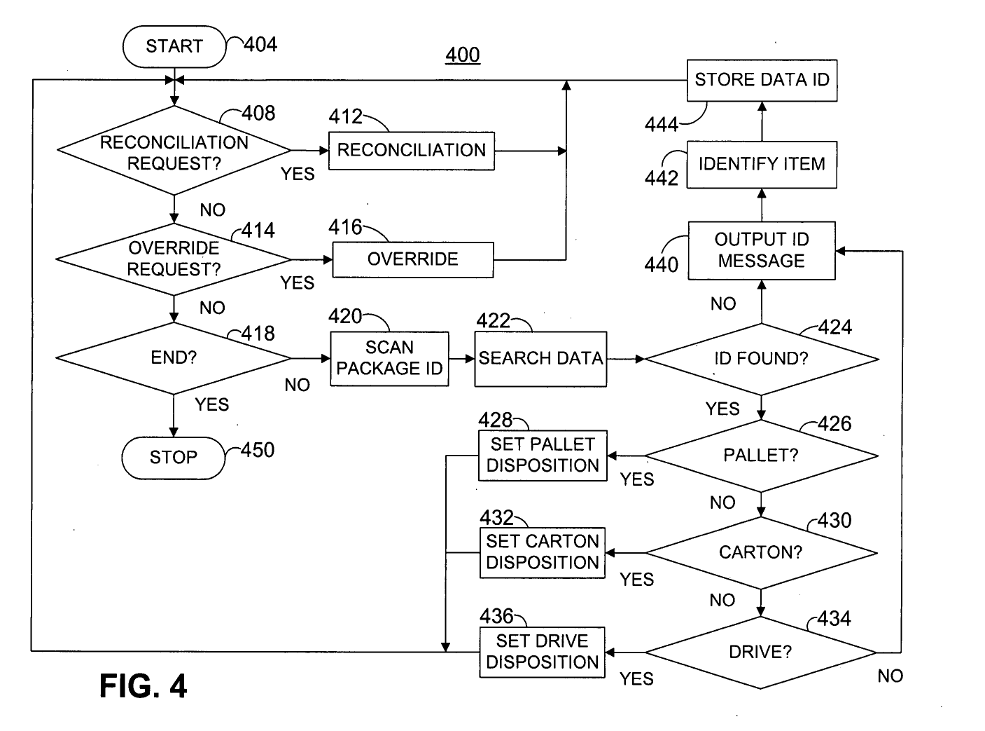

FIG. 4 is a high-level flow diagram of one embodiment of a method 400 of obtaining data from disk drive inventory 156 in accordance with embodiments of the invention. Method 400 may be entered into at 404 when, for example, inventory data processing program 142 is activated. At 408, method 400 determines if an operator has made a reconciliation request. If a reconciliation request has been made then method 400 proceeds to 412 to perform reconciliation as described herein. In one embodiment, at 412 a reconciliation process is performed to reconcile data associated with disk drive 156 disposed at one or more inventory locations associated with disk drive data 154. Such a reconciliation process may be used to generate a report indicative of disk drive data 154 associated with data retrieved from disk drive inventory 156, disk drive data 154 not retrieved from disk drive inventory 156 but associated with such inventory locations, and disk drive data 154 retrieved from disk drive inventory 156 and not associated with such inventory locations, as described further below. If however, a reconciliation request has not been made, method 400 proceeds to 414.

At 414, method 400 determines if an operator has made a distributable status override request. If a distributable status override request has been made, method 400 proceeds to 416 to process such an override request such as described herein. In one embodiment, such an override request includes changing a distribution status of at least one disk drive inventory 156 associated with one or more inventory locations being processed. If at 414 an override request has not been made, method 400 determines if data processing is ended at 418. If processing has ended, method 400 proceeds to 450 and ends. If however, processing has not ended, method 400 proceeds to 420 to retrieve disk drive data from disk drive inventory 156.

At least some disk drive inventory data from disk drive inventory 156 is retrieved at 420. For example, input devices 110A-N may be used to scan and store data from data labels, e.g., package identification (ID), associated with disk drive inventory 156 into disk drive data 144. At 422, a search is made of memory 140 to determine if data retrieved is for a pallet. If such match is found in memory 140 then inventory data processing system 100 may emit an audible sound from output device 122 configured to emit such a sound.

If the data retrieved is for a pallet, then at 426, a pallet disposition determination is made at 428 and method 400 returns to 408. In one embodiment, at 428 a pallet disposition includes determining from disk drive data 144 which disk drives associated with such a pallet are distributable and not distributable. If however, at 426 data retrieved is not a pallet ID, then at 430 an inquiry is performed to determine if such retrieved data is indicative of a disk drive carton. If a disk drive carton, then a carton disposition is determined at 432 such as described further herein and method 400 returns to 408. In one embodiment, such a carton disposition determination includes determining from disk drive data 144 which disk drives inventory 156 associated with such a disk drive carton are distributable and not distributable. If however, at 430 disk drive data retrieved is not indicative of a carton then at 434 a determination if such retrieved data is indicative of a least one individual disk drive inventory 156 is performed. If such retrieved data is indicative at least one individual disk drive inventory 156 then a disk drive disposition is determined at 436 such as described further herein and method 400 returns to 408. Such a disk drive determination may include determining from disk drive data 144 if such an individual disk drive inventory 156 is distributable or not distributable.

If a determination is made at 424 that not at least one individual disk drive inventory 156 is found, then an error message is generated at 440 indicating that such a retrieved data was not found in memory 140. For example, inventory data processing system 100 may emit an audible sound from output device 122 configured to emit such a sound indicative of data not found. In one embodiment, a different audible beep is used distinguish between retrieving data found within memory 140 and data not found within memory 140. At 442 an operator, for example, enters data associated with the package type e.g., pallet, carton, or disk drive not found in memory 140. In one configuration, at 444, such data from package not found is stored in disk drive data 144 and method 400 proceeds to 408.

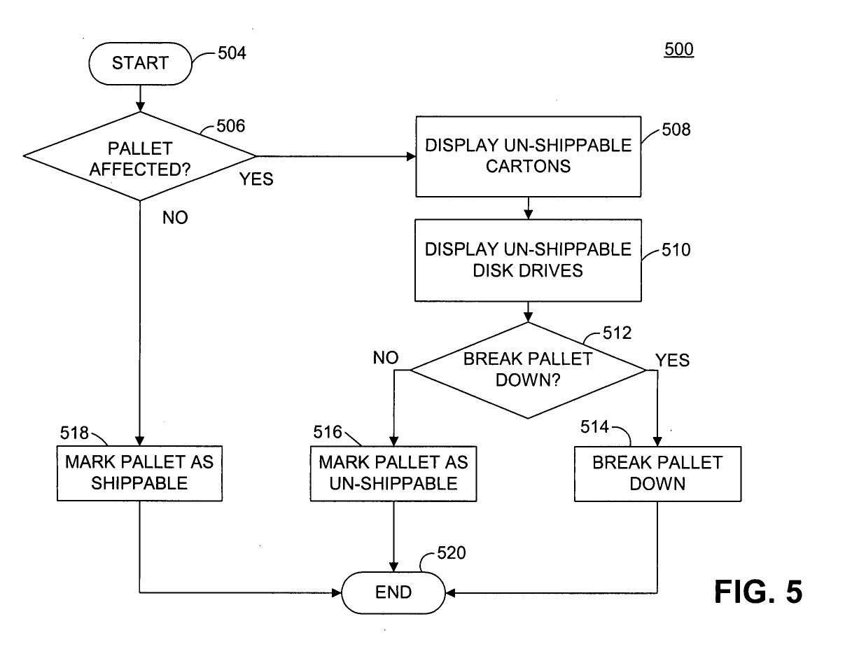

FIG. 5 is a high-level flow diagram of one embodiment of a method 500 of determining the disposition of palletized disk drive inventory 156 in accordance with embodiments of the invention. Method 500 may be entered into at 504 when, for example, inventory data processing program 142 is activated, and data is retrieved from disk drive inventory 156. At 506, a determination is performed to determine if a pallet associated with data retrieved from such disk drive inventory 156 contains both distributable and not distributable disk drive inventory 156. If at 506 such a pallet contains both distributable and not distributable disk drive inventory 156, then at 508 and 510 method 500 generates reports indicative of a number of not distributable cartons of disk drive inventory 156, and individual disk drive inventory 156 associated with such a pallet, respectively. If however at 506, such a pallet contains an amount of disk drive inventory 156 less than a distribution threshold, at 518, such data associated with such pallet is provided a distributable, i.e., shippable, status in memory 140 and method 500 ends at 520. For example, at 506, if a distribution threshold is set such that all disk drive inventory 156 must be distributable, then at 506 if all disk drive inventory 156 are distributable, then such pallet is assigned a distributable status at 518. At 512, a determination is made whether or not to break such disk drive inventory 156 down to separate distributable and not distributable cartons from one another. For example, method 500 may store in disk drive data 144 that such a pallet is not distributable and that some or all of the disk drive cartons and disk drive inventory 156 associated with such a pallet are not distributable. If at 512, a determination is made to break such a pallet inventory down, at 514, an instruction to break such a pallet down may be provided indicative thereof to an operator, for example, and method 500 ends at 520. However, at 512 if a determination is made that such palletized disk drive inventory 156 should not be broken down into distributable and not distributable cartons and disk drive inventory 156, then at 516 such pallet is assigned a not distributable status in memory 140 and method 500 ends at 520.

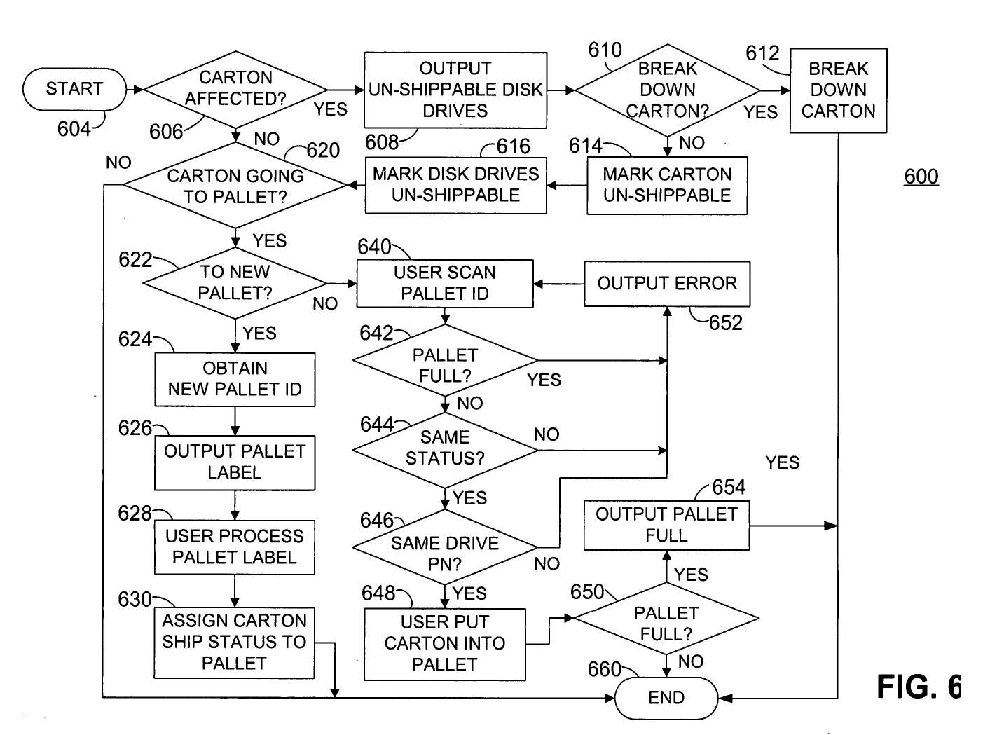

FIG. 6 is a high-level flow diagram of one embodiment of a method 600 of determining distributable disposition of one or more cartons of disk drive inventory 156 in accordance with embodiments of the invention. Method 600 may be entered into at 604 when, for example, inventory data processing program 142 is activated, and data is retrieved from disk drive inventory 156. At 606, a determination if a carton of disk drive inventory 156 contains both distributable and not distributable disk drive inventory 156 is performed. If such a carton of disk drive inventory 156, i.e., carton, has less than an acceptable pre-determined threshold of disk drive inventory 156 that is deemed not distributable, method 600 proceeds to 620. If such a carton contains not distributable disk drive inventory 156 above such a pre-determined threshold, at 608 method 600 generates data indicative thereof, stores such data in memory 140, and proceeds to 610. For example, at 606, if the pre-determined threshold is set such that all disk drive inventory 156 must be distributable, then at 606 if any of disk drive inventory 156 are not distributable, then method 600 generates data indicative thereof at 608, stores such data in memory 140, and proceeds to 610. At 610, a determination is made whether or not to break such a carton into distributable and not distributable disk drive inventory 156. If at 610, a decision is made to break the carton into distributable and not distributable disk drive inventory 156, then at 612 an instruction to break such a carton of disk drive inventory 156 is generated, and method 600 ends at 660. If however, a determination is made to not break such a carton into distributable and not distributable disk drive inventory 156, method 600 proceeds to 614. At 614, such a carton is marked as not distributable. At 616, a predetermined number of disk drive inventory 156 associated with such a carton are marked as not distributable. In one configuration, all of disk drive inventory 156 associated with such a not distributable carton are marked as not distributable.

At 620, a determination is made whether or not a carton of disk drive inventory 156, e.g., a distributable or not distributable carton, is going to be assigned to a pallet or may stand alone. If such a carton at 620 is not to be assigned to a pallet for distribution, e.g., such carton stands alone, and then method 600 ends at 660. If however, at 620 a carton is to be assigned to a pallet then method 600 proceeds to 622. At 622, a determination is made whether or not to assign such a carton to a new pallet, e.g., a pallet that is different from the pallet currently associated with the carton. If such a determination is that a carton is not to be assigned to a new pallet, method 600 proceeds to 640 described below and keeps such a carton assigned to its current pallet. However, if such a determination is that a carton is to be assigned to a new pallet, method 600 proceeds to 624 to obtain a new pallet ID. For example, an operator may enter a new data ID for a new pallet using input device 120 or retrieve data from a data ID label from such new pallet, which may then be stored in memory 140 as a new pallet assignment for such a carton. In one configuration, at 626, a pallet label is assigned and printed with such a new data ID using output device 122. An operator process such a new data ID label at 628. For example, at 628 an operator may place such a new data label on a new pallet as a new pallet ID “header” label. At 630, method 600 assigns a distributable status to such new pallet and ends at 660.

Referring back to 622, if a current pallet is to be used, at 640, an operator retrieves or enters a current pallet data ID associated with a carton of disk drive inventory 156 being processed. A determination is made at 642 if such a current pallet is full. If such a current pallet is full then at 652 an error message is generated. If however at 642, such a current pallet is not full then at 644 a determination is made whether or not other cartons associated with such current pallet have an identical distributable status as such current carton being processed. If one or more of such other cartons have a different distributable status, then an error message is generated at 652 and method 600 returns to 640. If however, a predetermined amount of such other cartons have an identical distributable status, then method 600 proceeds to 646. For example, if such predetermined amount of such other cartons is “all cartons must have identical distributable status” then if all cartons have an identical distributable status method 600 proceeds to 646. At 646, a determination is made whether or not disk drive inventory 156 associated with such carton have an identical data ID, e.g., part number. If one or more of such disk drive inventory 156 have a different data ID, then an error message is generated at 652 and method 600 returns to 640. If however, all disk drive inventory 156 have an identical data ID, then method 600 proceeds to 648 and generates a request to have an operator place such a current carton of disk drive inventory 156 on the current pallet and then records an assignment of such current carton to such current pallet in memory 140. At 650, a determination is made whether or not the current pallet is full. If such a current pallet is full, then an output indicative thereof is made at 654 and method 600 ends at 660. However, at 650 if such a current pallet is not full then method 600 ends at 660.

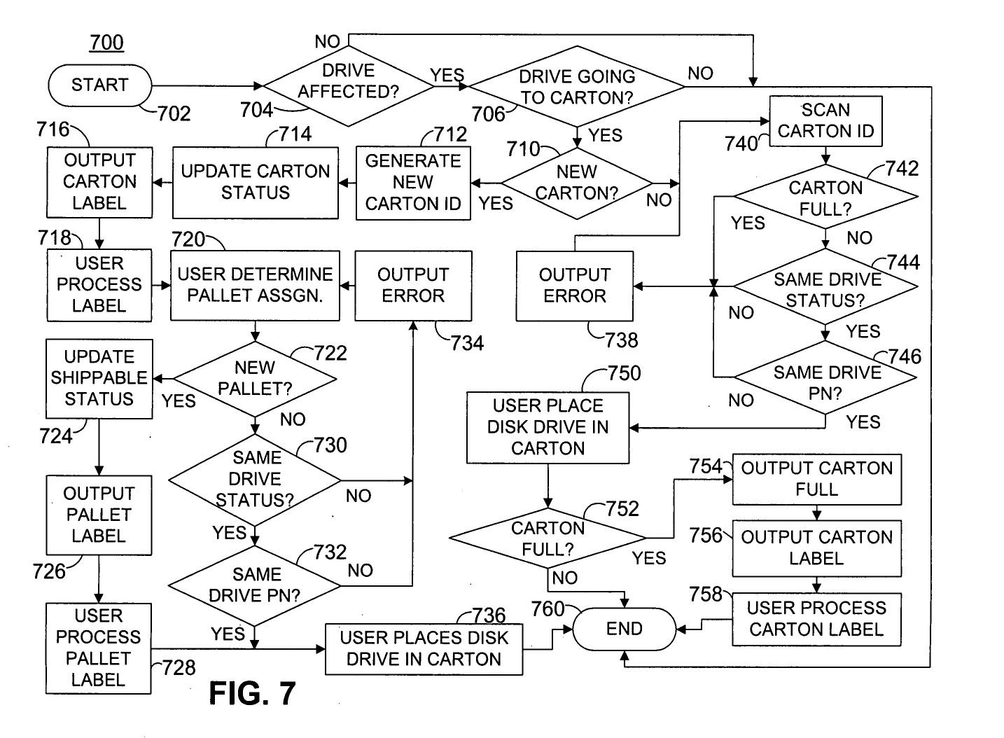

FIG. 7 is a high-level flow diagram of one embodiment of a method 700 of determining distributable disposition of disk drive inventory 156 in accordance with embodiments of the invention. Method 700 may be entered into at 702 when, for example, inventory data processing program 142 is activated, and data is retrieved from disk drive inventory 156. At 704, a determination is made if such an individual disk drive inventory 156 is distributable or not distributable. If such an individual disk drive inventory 156 is not affected, i.e., may be distributed independently and is distributable, method 700 proceeds to 760 and ends. If however, the individual disk drive inventory 156 is affected, i.e., cannot be distributed independently method 700 assigns a distributable or not distributable status to such individual disk drive inventory 156 in memory 140. At 706 a determination is made whether or not such an individual disk drive inventory 156 is going to be assigned to a carton. If such an individual disk drive inventory 156 is not going to be assigned to a carton, e.g., the individual disk drive inventory 156 stands alone, then method 700 ends at 760. If however, at 706 such an individual disk drive inventory 156 is to be assigned to a carton then method 700 proceeds to 710.

At 710, a determination is made whether or not such an individual disk drive inventory 156 is going to be assigned to a new carton, e.g., another carton not currently associated with such individual disk drive inventory 156. If such an individual disk drive inventory 156 is to be assigned to a new carton then at 712 a new carton data ID is generated indicative thereof. At 714 method 700 updates the distributable status of the new carton to the distributable status of such individual disk drive inventory 156. A new carton label is generated at 716 indicative thereof. For example, for individual disk drive inventory 156 not shippable a new carton label may be generated that includes a “not distributable” status of such new carton. At 718, a user may process such a new carton label. For example, at 716, a new carton label may be printed using output device 122 and at 718, an operator may attach such a printed label on such a new carton. At 720, an operator determines whether such new carton is to be assigned to a new pallet, i.e., pallet not associated with such new carton, or a current pallet already associated with such a new carton and method 700 proceeds to 722.

At 722, if such new carton is to be assigned to a new pallet, method 700 proceeds to 724. At 724, a data ID of such new pallet is retrieved, updated to the same distributable status as such current carton, and stored in memory 140. A pallet data ID label indicative of such new distributable status is generated at 726. An operator processes such a pallet data ID label at 728. For example, at 726 output device 122 may print a pallet data ID label, including a data indication that such a new pallet is distributable or not distributable, which is attached to such a new pallet at 728 by an operator. An operator may be instructed to place such disk drive inventory 156 at 736 into such new carton and method 700 ends at 760.

At 722 however, if a determination is made that a current pallet is to be used, then at 730 method 700 determines if other disk drive inventory associated with such a current pallet have an identical distribution status. If other disk drive inventory associated with such a current pallet does not have an identical distribution status then an error is generated at 734 and method 700 proceeds to 720. If however, at 730, other disk drive inventory associated with such a current pallet have an identical distribution status then at 732 a determination is made whether or not such disk drive inventory 156 have an identical data ID, e.g., part number, model number, etc. For example, if such disk drive inventory 156 does not have an identical part number then method 700 proceeds to 734 to generate an error and returns to 720. If however, at 732 such disk drive inventory have an identical part number then method 700 proceeds to 736. In one embodiment, method 700 may provide an operator instructions to package such disk drive inventory 156 into a new carton at 736 and then end at 760.

Referring back to 710. If at 710 an individual disk drive inventory 156 is to use a carton currently assigned, i.e., current carton, to such disk drive inventory 156, method 700 proceeds to 740 to retrieve a data ID for such current carton. For example, an operator may retrieve, e.g., scan, data from an ID label associated with such a current carton using input device 110A-N. At 742 a determination is made whether or not such a current carton is full. If such current carton is full then an error is generated at 738 and method 700 returns to 740. If however at 742 such current carton is not full, then a determination is made at 744 if the distributable individual disk drive inventory 156 has an identical distributable status as other disk drive inventory associated with such current carton. If such individual disk drive inventory 156 does not have an identical distributable status as other disk drive inventory associated with such current carton then method 700 proceeds to 738, outputs an error indicative thereof, and returns to 740. However, if at 744 such individual disk drive inventory 156 has an identical distributable status as other disk drive inventory associated with such current carton then method 700 proceeds to 746 to determine if such individual disk drive inventory 156 has the same part number as other individual disk drive inventory associated with the current carton. If at 746 such individual disk drive inventory 156 does not have the same part number, e.g., model number, etc., then method 700 proceeds to 738 and generates and error indicative thereof and returns to 740. If at 746 such individual disk drive inventory 156 has the same part number then method 700 proceeds to 750.

In one embodiment, method 700 may provide an operator at 750 an instruction to place such disk drive inventory 156 into a current carton. At 752 a determination is made whether or not such current carton is full. If such current carton is not full then method 700 ends at 760. If however, such current carton is full, then at 754 method 700 generates data indicative thereof. For example, inventory data processor 104 may output a display indicative of such current carton being full using output device 122. At 756, method 700 generates a current carton data ID label that includes distributable or not distributable data associated with at least some of the associated packaged disk drive inventory 156. At 758, an operator processes such a current carton data label and method 700 ends at 760. For example, an operator may receive a current carton data label printed by output device 122 and affix such current carton data ID label on such current carton for labeling thereof.

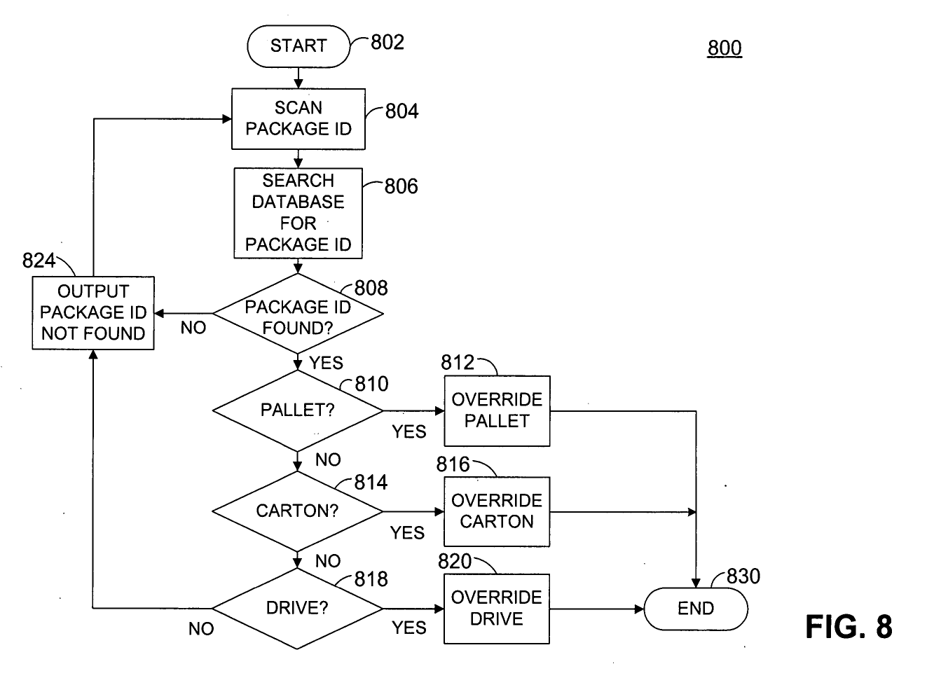

FIG. 8 is a high-level flow diagram of one embodiment of a method 800 of overriding distributable package status in accordance with embodiments of the invention. Method 800 may be entered into at 802 when, for example, inventory data processing program 142 is activated, and data is retrieved from disk drive inventory 156. At 804, data ID from a disk drive inventory 156 is retrieved therefrom. In one embodiment, an operator may use input devices 110A-N to scan data ID labels associated with disk drive inventory 156 including data labels, for example, associated with pallets and cartons stored at one or more distribution locations such as a FG inventory. At 806, disk drive data 144 is searched to determine if packaging associated with such retrieved package ID is a pallet, carton, or disk drive. If such retrieved package ID is not found at 808 in disk drive data 144, at 824 method 800 generates an error message indicative thereof and proceeds to 804. For example, inventory data processor 104 may generate an error message using output device 122. If however at 808, such a data ID is found, then at 810 a determination is made whether or not such data ID is associated with a pallet type of disk drive packaging.

If at 810 such a retrieved package ID matches a pallet then in one configuration an override pallet operation is performed. In one configuration of such pallet override operation, an operator is queried to determine if a change to a current distributable status of such a pallet is requested, and if so, a current distributable status of such pallet is changed to an opposite distributable status at 812 and method 800 ends at 830. For example, if a current distribution status is “not distributable” then method 800 will change such current not distributable status to a “distributable” status at 812. If however at 810 such a package ID does not match a pallet then method 800 proceeds to 814.

If at 814 such retrieved package ID matches disk drive data 144 associated with a carton then in one configuration an override carton operation is performed. In one configuration of such a carton override operation, an operator is queried to determine if a change to a current distributable status of such carton is requested, and if so, a current distributable status of such carton is changed to an opposite status at 816 and method 800 ends at 830. For example, if a current distribution status is “not distributable” then method 800 will change such current not distributable status to “distributable” status. If however at 814 such retrieved data ID does not match a carton ID data then method 800 proceeds to 818.

If at 818 such a package ID matches a disk drive data 144 then in one configuration an override disk drive operation is performed. In one configuration of such a disk drive override operation, an operator is queried to determine if a change to a current distributable status of such disk drive is requested, and if so, a current distributable status of such disk drive is changed to an opposite status at 820 and method 800 ends at 830. For example, if a current distribution status is “not distributable” then method 800 will change such current not distributable status to “distributable” status. If however at 818 such a data ID does not match a carton ID data then method 800 proceeds to 824 to generate an error message and then proceeds to 804.

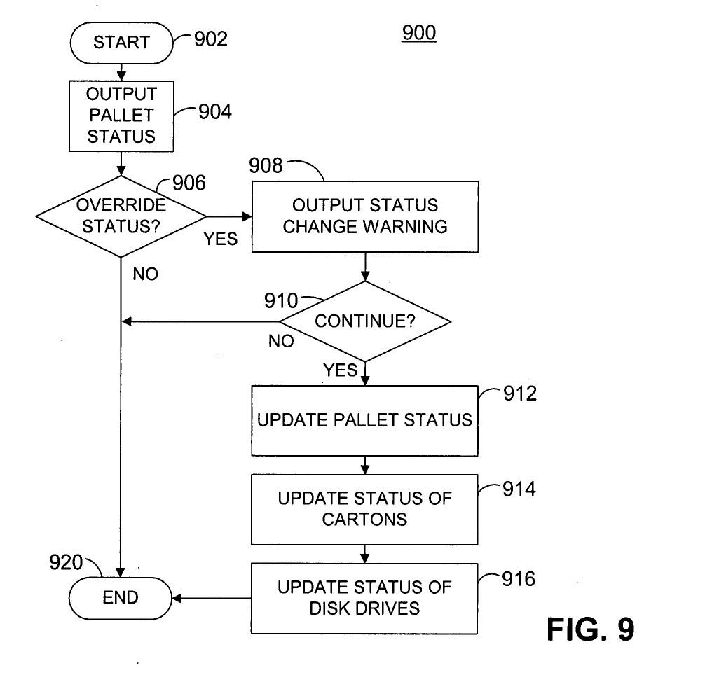

FIG. 9 is a high-level flow diagram of one embodiment of a method 900 of overriding a distributable status of a pallet in accordance with embodiments of the invention. Method 900 may be entered into at 902 when, for example, inventory data processing program 142 is activated, and data is retrieved from disk drive inventory 156. At 904, method 900 generates data indicative of retrieved distributable status of at least one pallet of disk drive inventory 156. At 906, a determination is made by an operator for example, if an override of such current distributable status is requested. If not requested, then method 900 proceeds to 920 and ends. If however at 906 an override of such current distributable status is requested, at 908 method 900 generates a warning message to an operator requesting such override to confirm that such override is acceptable. At 910, a determination is made whether or not to continue with such an override request. If at 910, an operator confirms such an override request, then at 912 method 900 changes a current distributable status to an opposite distributable status. At 914, method 900 updates all of the cartons associated with such pallet to an identical distributable status. At 916, method 900 updates all of the disk drive inventory data associated with such pallet to an identical distributable status and ends at 920. In one configuration, the distributable status retrieved of disk drive inventory 156 including pallets, cartons, and disk drives associated with such pallets are changed to the same distributable status and stored in memory 140.

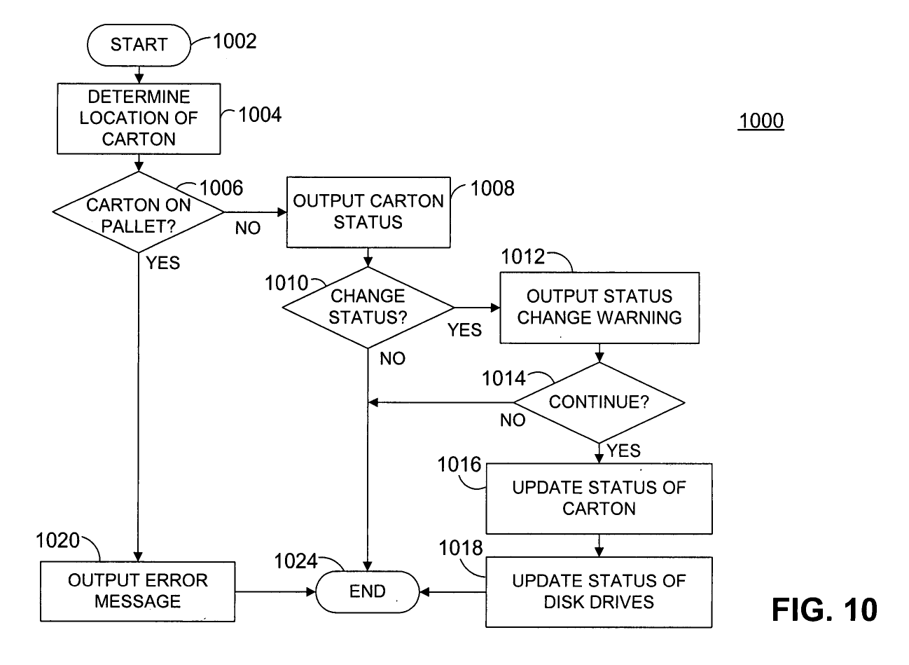

FIG. 10 is a high-level flow diagram of one embodiment of a method 1000 of overriding a distributable status of a carton of disk drive inventory 156 in accordance with embodiments of the invention. Method 1000 may be entered into at 1002 when, for example, inventory data processing program 142 is activated and data is retrieved from disk drive inventory 156. At 1004, method 1000 determines if such carton being processed is associated with a pallet. If at 1006 such carton is determined to be associated with a pallet then method 1000 generates an error message at 1020 and ends at 1024. If however at 1006, such carton is determined not to be associated with a pallet, then method 1000 generates a distributable carton status at 1008. At 1010, a request may be made by an operator, for example, to override such current carton distributable status. At 1010, if such a request is not confirmed by such an operator, for example, then method 1000 proceeds to 1024 and ends. If however, at 1010 an override of such current distributable status is confirmed, then at 1012 method 1000 generates a warning message to an operator requesting such override to confirm that such an override is acceptable. At 1014, a determination is made by such operator, for example, whether or not to continue with such an override request. If at 1014 a confirmation is not made, e.g., the operator chooses to keep a carton status the same, then method 1000 proceeds to 1024 and ends. If however at 1014, an operator confirms such request, then at 1016 method 1000 changes a current distributable status of such carton to an opposite distributable status. For example, if a current distribution status is “not distributable” then method 1000 will change such current not distributable status to “distributable” status. In one embodiment, at 1018, method 1000 updates all of the disk drive inventory data associated with such carton to such opposite distributable status and ends at 1024. In one configuration, such changed distributable status of such carton and associated disk drive inventory 156 are stored in memory 140.

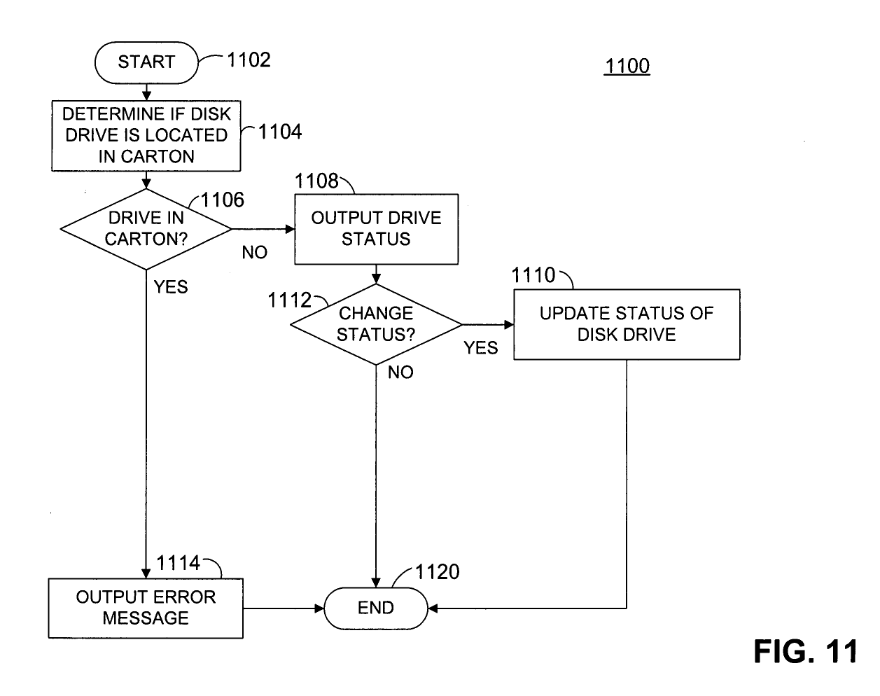

FIG. 11 is a high-level flow diagram of one embodiment of a method 1100 of overriding a distributable status of disk drive inventory 156 in accordance with embodiments of the invention. Method 1100 may be entered into at 1102 when, for example, inventory data processing program 142 is activated and data is retrieved from disk drive inventory 156. At 1104, method 1000 determines if such disk drive inventory 156 is associated with a carton. If at 1106 such disk drive inventory 156 is determined to be associated with a carton then method 1100 generates an error message at 1114 and ends at 1120. If however at 1106 such disk drive inventory 156 is determined not to be associated with a carton then method 1100 generates a distributable disk drive inventory status at 1108. For example, inventory data processor 104 may output a display indicative of such a disk drive distributable status via output device 122. At 1112, a request is made by an operator, for example, to override such current disk drive distributable status. At 1112, if such a request is not confirmed then method 1000 proceeds to 1120 and ends. If however at 1112, an operator confirms such an override request, then at 1110 method 1100 changes a current distributable status of such disk drive inventory to an opposite distributable status and ends at 1120. For example, if a current distribution status is “not distributable” then method 1100 will change such current not distributable status to “distributable” status. In one configuration, such opposite distributable status of such disk drive data 144 and associated disk drive inventory 156 are stored in memory 140.

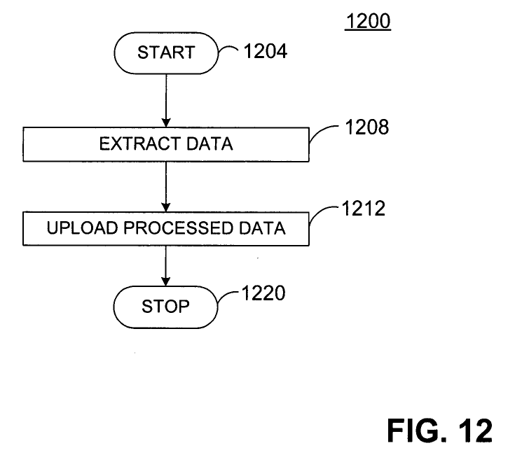

FIG. 12 is a high-level flow diagram of one embodiment of a method 1200 of processing disk drive inventory 156 distributable status data in accordance with embodiments of the invention. Method 1200 may be entered into at 1204 when, for example, inventory data processing program 142 is activated and data is retrieved from disk drive inventory 156. At 1208, disk drive data 144, data retrieved from at least some disk drive inventory 156, and processed disk drive data 154 from independent inventory database are prepared for upload to at least one independent inventory database 150. In one embodiment, such disk drive data 144 includes disk drive data attributes described herein. For example, disk drive data 144 may include disk drive inventory attributes such as stop disk drive shipment data, revision data, sub-inventory, bin data, item data, pallet data, top data, case data, date of manufacturer, predefined serial attributes data, and the like. Disk drive data 144 may include distributable status of at least some disk drive inventory 156. At 1212, method 1200 provides such processed disk drive data 144 to independent inventory database 150 and ends at 1220. In summary, method 1200 associates disk drive data 154 with disk drive data 144 that includes at least some data retrieved, e.g., scanned, from disk drive inventory 156, distributable status of disk drive inventory 156, and distributable status of previously stored disk drive data 154 from independent inventory database 150.

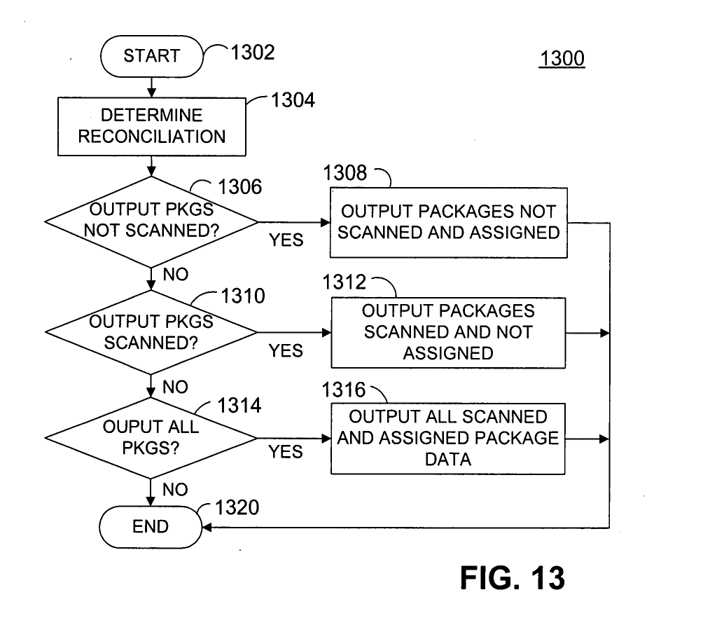

FIG. 13 is a high-level flow diagram of one embodiment of a method 1300 of reconciling disk drive inventory data in accordance with embodiments of the invention. Method 1300 may be entered into at 1302 when, for example, inventory data processing program 142 is activated and data is retrieved from disk drive inventory 156. At 1304, method 1300 processes data retrieved from disk drive inventory 156 to disk drive data 144 described herein and previously downloaded disk drive data 154. At 1306, a determination is made whether or not to output disk drive inventory data 144 associated with disk drive inventory 156, e.g., pallet data, carton data, disk drive inventory data, not retrieved but included in disk drive data 154. If a determination at 1306 is made to output disk drive inventory data associated with such disk drive inventory data not retrieved but included in disk drive data 154 then at 1308 method 1308 generates data indicative thereof and ends at 1320. For example, inventory data processor 104 may provide a report via output device 122 illustrating disk drive inventory 156 associated with disk drive data 154 but not retrieved from the one or more disk drive inventory locations.

At 1310, a determination is made whether or not to output data retrieved from disk drive inventory 156 but not included in disk drive data 154. If a determination is made to output data retrieved from disk drive inventory 156 but not included in disk drive data 154, then at 1312 method 1300 generates data indicative thereof and ends at 1320. For example, inventory data processor 104 may provide a report via output device 122 illustrating data retrieved from disk drive inventory 156 that is not included in disk drive data 154.

At 1314, a determination is made whether or not to output all data including data retrieved from disk drive inventory 156 but not included in disk drive data 154, and data associated with disk drive inventory 156 that is included in disk drive data 154 but not retrieved from the one or more disk drive inventory locations. If at 1314 a determination is made to output all data, at 1316 method 1300 generates data indicative thereof and ends at 1320. For example, inventory data processor 104 may provide a report via output device 122 illustrating data scanned via input device 110A-N from disk drive inventory 156 that is include in disk drive data 154, and disk drive inventory 156 associated with disk drive data 154 that was not scanned.

While the foregoing is directed to embodiments of the invention, other and further embodiments of the invention may be devised without departing from the basic scope thereof. The scope of the invention is determined by the claims that follow and equivalents.

1. A method of segregating disk drive inventory into distributable disk drive inventory and not distributable disk drive inventory, comprising:
determining if at least one of the disk drive inventory is not distributable using at least some disk drive attribute data associated with one or more of the disk drive inventory;
associating a not distributable status with the not distributable disk drive inventory; and
associating a distributable status with the distributable disk drive inventory.

2. The method of claim 1, wherein determining if at least one of the disk drive inventory is not distributable comprises comparing the disk drive inventory to disk drive inventory data indicative of not distributable disk drive inventory.

3. The method of claim 2, wherein comparing the disk drive inventory to the disk drive inventory data comprises comparing at least some of the attribute data to the disk drive inventory data to determine the not distributable disk drive inventory.

4. The method of claim 1, wherein determining if at least one of the disk drive inventory is distributable comprises comparing the disk drive inventory to disk drive inventory data indicative of the distributable disk drive inventory.

5. The method of claim 4, wherein comparing the disk drive inventory to the disk drive inventory data comprises comparing at least some of the attribute data with the disk drive inventory data to determine the distributable disk drive inventory.

6. The method of claim 1, further comprising preventing the distributable disk drive inventory and not distributable disk drive inventory from being grouped together in a common shipping package.

7. The method of claim 6, further comprising separating the distributable disk drive inventory from the not distributable disk drive inventory into separate common shipping packages.

8. The method of claim 1, further comprising generating reconciliation data indicative of at least some of the segregated disk drive inventory.

9. A method of identifying and physically separating physical disk drive inventory into distributable disk drive inventory and not distributable disk drive inventory, comprising:
retrieving inventory data from the physical disk drive inventory;
determining from the retrieved disk drive inventory data a type of packaging associated with the disk drive inventory;
comparing disk drive attribute data of the disk drive inventory to data indicative of a not distributable status of the disk drive inventory; and
determining if the disk drive inventory associated with the packaging is not distributable from the comparison between the attribute data and data indicative of a not distributable status, if the disk drive inventory within the inventory package is determined to be not distributable then generating data indicative thereof, and wherein if at least some of the disk drive inventory associated with the inventory package is not distributable then determining if the disk drive inventory within the package is segregable into distributable disk drive inventory and not distributable disk drive inventory.

10. The method of claim 9, wherein the retrieving inventory data from the disk drive inventory comprises scanning data labels associated with the physical disk drive inventory.

11. The method of claim 9, wherein the determining from the retrieved disk drive inventory data the type of packaging associated with the disk drive inventory comprises comparing at least some of retrieved inventory data to package type data.

12. The method of claim 9, wherein the determining if the disk drive inventory associated with the packaging is not distributable comprises determining if the type of packaging associated with the disk drive inventory is a pallet.

13. The method of claim 9, wherein the determining if the disk drive inventory associated with the packaging is not distributable comprises determining if the type of packaging associated with the disk drive inventory is a carton.

14. The method of claim 9, wherein the determining if the disk drive inventory associated with the packaging is not distributable comprises determining if the type of packaging associated with the disk drive inventory is a disk drive.

15. The method of claim 9, further comprising segregating the disk drive inventory into distributable disk drive inventory and not distributable disk drive inventory if the disk drive inventory within the package is determined to be segregable into distributable disk drive inventory and not distributable disk drive inventory.

16. A system for identifying and separating disk drive inventory distributable to one or more inventory locations into distributable disk drive inventory and not distributable disk drive inventory, comprising:
a memory means containing a disk drive inventory processing program and a list of disk drive distribution statuses; and
a processor means which, when executing the inventory processing program is configured to:
retrieve disk drive inventory data from the disk drive inventory;
determine from the retrieved disk drive inventory data a type of packaging associated with the disk drive inventory;
compare disk drive attribute data of the disk drive inventory to data indicative of a distributable status of the disk drive inventory; and
determine from the comparison the distributable disposition of the package.

17. The system of claim 16, further comprising at least one input device means for the retrieval of the inventory data.

18. The system of claim 16, wherein list of disk drive distribution statuses comprises at least one disk drive attribute data indicative of a disk drive disposition status.

19. The system of claim 16, wherein the packaging type comprises at least one of a disk dive package, a carton, a pallet, and combinations thereof.

20. The system of claim 16, wherein if the distributable disposition of the package is determined to be not distributable then the processor means which, when executing the inventory processing program is configured to determine if the disk drive inventory is separable into distributable disk drive inventory and not distributable disk drive inventory.

21. The system of claim 16, wherein if the disk drive inventory is determined to be separable into distributable disk drive inventory and not distributable disk drive inventory then the processor means which, when executing the inventory processing program is configured to provide data indicative thereof to an operator for disposition of the separable disk drive inventory.
